(19) United States
(12) Patent Application Publication
(10) Pub. No.: US 2020/0029291 A1
(43) Pub. Date: Jan. 23, 2020

(54) Adaptive Timing Adjustment Delay

(71) Applicant: Telefonaktiebolaget LM Ericsson (publ), Stockholm (SE)

(72) Inventor: Iana SIOMINA, TÄBY (SE)

(21) Appl. No.: 16/337,965

(22) PCT Filed: Sep. 28, 2017
(86) PCT No.: PCT/SE2017/050944

§ 371 Date: Mar. 29, 2019

Related U.S. Application Data
(60) Provisional application No. 62/402,081, filed on Sep. 30, 2016.

(51) Int. Cl. H04W 56/00; H04L 27/26

(52) U.S. Cl. CPC H04W 56/0045; H04L 27/2646

(57) ABSTRACT

According to some embodiments, a method for use in a radio node of adapting a timing adjustment delay parameter comprises obtaining information about timing adjustment for a cell, and determining a timing adjustment delay parameter for transmissions on the cell based on the obtained information about timing adjustment for the cell (e.g., numerology or coverage level) and at least one of a numerology and coverage level. The method further comprises applying a timing adjustment based on the determined timing adjustment delay parameter. In particular embodiments, determining the timing adjustment delay parameter comprises decreasing a timing adjustment delay as a subcarrier spacing of the numerology increases. In some embodiments, the radio node comprises a user equipment and the method further comprises transmitting a radio transmission according to the applied timing adjustment. In some embodiments, the radio node comprises a network node such as an eNodeB.

### TECHNICAL FIELD

Certain embodiments of the present disclosure relate, in general, to wireless communications and, more particularly, to adapting timing adjustment delay based on attributes of a particular cell.

### INTRODUCTION

Third Generation Partnership Project (3GPP) New Radio (NR) (i.e., 5G or Next Generation) architecture is illustrated in FIG. 1. The eNB refers to a 3GPP long term evolution (LTE) eNodeB, the gNB refers to a NR base station (BS) (one NR BS may correspond to one or more transmission/reception points), and the lines between the nodes illustrate particular 3GPP communication interfaces. FIGS. 2A and 2B illustrate various 3GPP deployment scenarios of NR BS.

3GPP NR refers to particular elements as “numerology.” For LTE, the term “numerology” includes the following elements: (a) frame duration; (b) subframe or transmission time interval (TTI) duration; (c) slot duration; (d) symbol duration and the number of symbols per slot and subframe; (e) subcarrier spacing; (f) sampling frequency; (g) Fast Fourier transform (FFT) size; (h) number of subcarriers per resource block (RB); number of RBs within the bandwidth (different numerologies may result in different numbers of RBs within the same bandwidth); (i) symbols per subframe; and (j) cyclic prefix (CP) length.

The values for the numerology elements in different radio access technologies are typically driven by performance targets (e.g., performance requirements impose constraints on usable subcarrier spacing sizes). For example, the maximum acceptable phase noise and the slow decay of the spectrum (impacting filtering complexity and guardband sizes) set the minimum subcarrier bandwidth for a given carrier frequency. The required cyclic prefix sets the maximum subcarrier bandwidth for a given carrier frequency.

The numerology used for existing radio access technologies (RATs) is normally static. A user equipment (UE) may typically trivially derive the numerology (e.g., by one-to-one mapping to RAT, frequency band, service type, such as multimedia broadcast multicast service (MBMS), etc.).

In LTE downlink, which is orthogonal frequency division multiplexing (OFDM)-based, the subcarrier spacing is 15 kHz for normal cyclic-prefix (CP) and 15 kHz and 7.5 kHz (i.e., the reduced carrier spacing) for extended CP, where the latter is allowed only for MBMS-dedicated carriers.

In NR, which is also based on OFDM, multiple numerologies are supported for general operation. Multiple numerologies may be multiplexed in the frequency and/or time domain for the same or different UEs. A scaling approach (e.g., based on a scaling factor 2n, n=1, 2, . . .) may be used for deriving subcarrier spacing candidates for NR (e.g., 15 kHz, 30 kHz, 60 kHz, etc.). The numerology-specific subframe durations may be determined in ms based on the subcarrier spacing (e.g., subcarrier spacing of (2^{m}*15) kHz gives ½^{m} ms).

NR may support subcarrier spacings of up to 960 kHz (the highest values correspond to millimeter-wave based technologies). NR may also support multiplexing different numerologies within a same NR carrier bandwidth, as well as frequency division multiplexing (FDM) and/or time division multiplexing (TDM). Multiple frequency/time portions using different numerologies may share a synchronization signal, where the synchronization signal refers to the signal itself and the time-frequency resource used to transmit the synchronization signal. The numerology used may be selected independently of the frequency band, although typically a very low subcarrier spacing will not be used at very high carrier frequencies. FIG. 3 illustrates example carrier spacings with respect to the frequency and cell range.

LTE specifies particular requirements for uplink timing. To preserve the orthogonality in uplink, the uplink transmissions from multiple UEs are time aligned at the eNodeB. Because UEs may be located at different distances from the eNodeB, each of the UEs will initiate its uplink transmission at different times. A UE far from the eNodeB will start transmission earlier than a UE close to the eNodeB. This may be achieved, for example, by timing advance (TA) of the uplink transmissions. Using TA, a UE starts its uplink transmission before a reference time given by the timing of the downlink signal received by the UE. The UE transmission timing may be adjusted based on TA commands received from the network (e.g., in a MAC message) or autonomously by the UE.

Carrier aggregation (CA) capable UEs may also support multiple TAs. One TA command may be associated with one TA group (TAG), where all cells in the TAG may use the same TA. A TAG containing at least a PCell is a pTAG. The PCell is used as a reference cell for deriving the timing in the pTAG. Other TAGs may use any SCell as a reference. In dual connectivity, a UE may be configured with a psTAG containing at least a PSCell used as a reference for deriving the timing for the psTAG.

TAGs are configured by the eNodeB. Each sTAG has an associated sTAG ID and a time alignment timer (TAT). The TAT starts when a serving cell of the TA group performs random access and is thereby assigned its first TA value. The TAT is then restarted each time the TA value used by the TA group is updated (e.g., upon reception of a TA command (TAC)). A SCell is considered uplink time aligned when the associated TAT is running and it may then, if activated, transmit on the uplink. When TAT is expired, the serving cells associated with that TAT may not perform any uplink transmission except for random access request.

LTE includes two types of TA requirements: TA adjustment delay and TA adjustment accuracy. The TA adjustment delay specifies that the UE shall adjust the timing of its uplink transmission timing at sub-frame n+6 for a TA command received in sub-frame n. The TA adjustment accuracy specifies that the UE shall adjust the timing of its transmissions with a relative accuracy better than or equal to ±4*TS seconds to the signaled timing advance value compared to the timing of preceding uplink transmission.

A multi-carrier system (also referred to as carrier aggregation (CA)) enables the UE to simultaneously receive and/or transmit data over more than one carrier frequency. Each carrier frequency may be referred to as a component carrier (CC) or simply a serving cell in the serving sector, more specifically a primary serving cell or secondary serving cell. The multi-carrier concept is used in both high speed packet access (HSPA) and LTE. The LTE standard supports up to five aggregated carriers where each carrier is limited in the radio frequency (RF) specifications to have one of six bandwidths: 6, 15, 25, 50, 75 or 100 RB (corresponding to 1.4, 3, 5, 10, 15 and 20 MHz, respectively).

The number of aggregated CC, as well as the bandwidth of the individual CC, may differ for uplink and downlink. A symmetric configuration refers to the same number of CCs in downlink and uplink, whereas an asymmetric configuration refers a different number of CCs in downlink and uplink. The number of CCs configured in the network may be different than the number of CCs seen by a terminal. For example, a terminal may support more downlink CCs than uplink CCs, even though the network offers the same number of uplink and downlink CCs.

In CA, the terminal is configured with a primary CC (or cell or Serving cell), which is referred to as the Primary Cell or PCell. The PCell is significant, for example, because control signaling is signaled on PCell. Also, the UE performs monitoring of the radio quality on the PCell. A CA capable terminal can, as explained above, be configured with additional carriers (or cells or serving cells) which are referred to as Secondary Cells (SCells).

In dual connectivity (DC), a UE in RRC_CONNECTED state is configured with a master cell group (MCG) and a secondary cell group (SCG). A cell group (CG) is a group of serving cells associated with either the MeNB or the SeNB, respectively. The MCG and SCG are defined as follows: a MCG is a group of serving cells associated with the MeNB comprising the PCell and optionally one or more SCells; a SCG is a group of serving cells associated with the SeNB comprising the pSCell (Primary SCell) and optionally one or more SCells.

Serving cell managements is performed by MAC commands that control (de)configuration of SCell(s) (i.e., SCell addition), (de)activation of SCell(s), and setting up and releasing PSCell in DC. The PCell is always activated, while SCell can be activated or deactivated.

### SUMMARY

Using conventional TA adjustment delay with NR includes particular problems. For example, one goal of NR is to reduce latency. The conventional TA adjustment delay specified in LTE may be too long, resulting in unnecessary latency. As another example, NR may include different numerologies for uplink and downlink, and two or more numerologies may be used in downlink and/or uplink. Thus, each numerology may benefit from its own TA adjustment delay, hereinafter referred to as a timing adjustment delay to differentiate from the conventional TA adjustment delay as specified in LTE. Furthermore, cells with multiple numerologies may exist in the same TAG, which makes it difficult to use a single TA for all cells in a TAG.

Particular embodiments include user equipment and network nodes for adapting timing adjustment delay based on attributes of a particular cell. According to some embodiments, a method for use in a radio node of adapting a timing adjustment delay parameter comprises obtaining information about timing adjustment for a cell, and determining a timing adjustment delay parameter for transmissions on the cell based on the obtained information about timing adjustment for the cell and at least one of a numerology and coverage level. The method further comprises applying a timing adjustment based on the determined timing adjustment delay parameter.

In particular embodiments, applying the timing adjustment comprises updating a timing parameter, a timer, or a counter associated with one or more transmissions of the radio network element. Determining the timing adjustment delay parameter for transmissions on the cell based on the numerology may comprise decreasing a timing adjustment delay as a subcarrier spacing of the numerology increases. When the radio node is in communication with a plurality of cells, the obtained numerology may comprise a reference numerology associated with one cell of the plurality of cells.

In particular embodiments, the obtained information about timing adjustment for the cell includes at least one of: an amount of timing adjustment; a timing adjustment delay; one or more parameters characterizing a reference with respect to which the timing adjustment is to apply; one or more parameters characterizing the timing adjustment including at least one of step size, frequency of the timing update, and maximum allowed adjustment; an indication of one or more links or a group of links for which the timing adjustment can be applied; and at least one of a carrier frequency, cell size, and cell range.

In particular embodiments, the one or more parameters characterizing the reference with respect to which the timing adjustment is to apply include at least one of a cell, a downlink or uplink link, a downlink or uplink time unit, a downlink or uplink transmission, a downlink or uplink signal, a reference numerology, a reference time or frequency resource, and a reference subband. The indication of the one or more links or the group of links for which the timing adjustment can be applied may include at least one of one or more cells, a timing advance group (TAG), and a transmission reception point (TRP) associated with a link.

In particular embodiments, obtaining information about timing adjustment for the cell comprises at least one of: receiving a message from another node; obtaining a predefined value, table, mapping, function, or rule; measuring a radio signal; obtaining a coverage characterization; obtaining a carrier aggregation (CA) configuration and TAG of the radio node; and obtaining a numerology used for a particular link or group of links.

In particular embodiments, determining the timing adjustment delay parameter comprises at least one of: determining a delay measured in an absolute time unit, measured in a radio time unit, or specified by a particular time resource; determining a delay based on a predefined value, table, mapping, function, or rule; determining a delay based on a radio measurement; and determining a delay based on history. The predefined rule may comprise at least one of: a shorter timing adjustment delay for a larger subcarrier spacing in uplink; a shorter timing adjustment delay for a larger subcarrier spacing in downlink; a shorter timing adjustment delay for a larger subcarrier spacing which is the largest or the smallest among downlink and uplink; a shorter delay for a smaller cell; a shorter delay when a radio measurement is below a threshold; a shorter delay for a cell bandwidth above a threshold; a shorter delay for a channel condition above a threshold; and a first delay for normal conditions and a second delay for extreme conditions.

In particular embodiments, the radio node comprises a user equipment. Applying the timing adjustment may comprise applying the timing adjustment within a timing adjustment delay period determined based on the timing adjustment delay parameter, or applying the timing adjustment within a particular time resource determined based on the timing adjustment delay parameter. The method may further comprise transmitting a radio transmission according to the applied timing adjustment, and/or indicating the timing adjustment capabilities of the user equipment to a controlling node.

In particular embodiments, the radio node comprises an eNodeB. Applying the timing adjustment may comprise sending the determined timing adjustment delay parameter to a user equipment. The method may further comprise receiving a radio transmission according to the applied timing adjustment.

According to some embodiments, a radio node capable of adapting a timing adjustment delay parameter comprises a memory coupled to a processor. The processor is operable to obtain information about timing adjustment for a cell, and determine a timing adjustment delay parameter for transmissions on the cell based on the obtained information about timing adjustment for the cell and at least one of a numerology and coverage level. The processor is further operable to apply a timing adjustment based on the determined timing adjustment delay parameter.

In particular embodiments, the processor is operable to apply the timing adjustment by updating a timing parameter, a timer, or a counter associated with one or more transmissions of the radio network element. The processor may be operable to determine the timing adjustment delay parameter for transmissions on the cell based on the numerology by decreasing a timing adjustment delay as a subcarrier spacing of the numerology increases. When the radio node is in communication with a plurality of cells, the obtained numerology may comprise a reference numerology associated with one cell of the plurality of cells.

In particular embodiments, the obtained information about timing adjustment for the cell further includes at least one of: an amount of timing adjustment; a timing adjustment delay; one or more parameters characterizing a reference with respect to which the timing adjustment is to apply; one or more parameters characterizing the timing adjustment including at least one of step size, frequency of the timing update, and maximum allowed adjustment; an indication of one or more links or a group of links for which the timing adjustment can be applied; and at least one of a carrier frequency, cell size, and cell range. The one or more parameters characterizing the reference with respect to which the timing adjustment is to apply may include at least one of a cell, a downlink or uplink link, a downlink or uplink time unit, a downlink or uplink transmission, a downlink or uplink signal, a reference numerology, a reference time or frequency resource, and a reference subband. The indication of the one or more links or the group of links for which the timing adjustment can be applied may include at least one of one or more cells, a timing advance group (TAG), and a transmission reception point (TRP) associated with a link.

In particular embodiments, the processor is operable to obtain information about timing adjustment for the cell by at least one of: receiving a message from another node; obtaining a predefined value, table, mapping, function, or rule; measuring a radio signal; obtaining a coverage characterization; obtaining a carrier aggregation (CA) configuration and TAG of the radio node; and obtaining a numerology used for a particular link or group of links.

In particular embodiments, the processor is operable to determine the timing adjustment delay parameter by at least one of: determining a delay measured in an absolute time unit, measured in a radio time unit, or specified by a particular time resource; determining a delay based on a predefined value, table, mapping, function, or rule; determining a delay based on a radio measurement; and determining a delay based on history.

The predefined rule may comprise at least one of: a shorter timing adjustment delay for a larger subcarrier spacing in uplink; a shorter timing adjustment delay for a larger subcarrier spacing in downlink; a shorter timing adjustment delay for a larger subcarrier spacing which is the largest or the smallest among downlink and uplink; a shorter delay for a smaller cell; a shorter delay when a radio measurement is below a threshold; a shorter delay for a cell bandwidth above a threshold; a shorter delay for a channel condition above a threshold; and a first delay for normal conditions and a second delay for extreme conditions.

In particular embodiments, the radio node comprises a user equipment. The processor may be operable to apply the timing adjustment by applying the timing adjustment within a timing adjustment delay period determined based on the timing adjustment delay parameter, or applying the timing adjustment within a particular time resource determined based on the timing adjustment delay parameter. The processor may be further operable to transmit a radio transmission according to the applied timing adjustment, and indicate the timing adjustment capabilities of the user equipment to a controlling node.

In particular embodiments, the radio node comprises an eNodeB. The processor may be operable to apply the timing adjustment by sending the determined timing adjustment delay parameter to a user equipment. The processor may be further operable to receive a radio transmission according to the applied timing adjustment.

According to some embodiments, a radio node capable of adapting a timing adjustment delay parameter comprises an obtaining module, a determining module, and an applying module. The obtaining module is operable to obtain information about timing adjustment for a cell. The determining module is operable to determine a timing adjustment delay parameter for transmissions on the cell based on the obtained information about timing adjustment for the cell and at least one of a numerology and coverage level. The applying module is operable to apply a timing adjustment based on the determined timing adjustment delay parameter.

Also disclosed is a computer program product. The computer program product comprises instructions stored on non-transient computer-readable media which, when executed by a processor, perform the steps of obtaining information about timing adjustment for a cell, and determining a timing adjustment delay parameter for transmissions on the cell based on the obtained information about timing adjustment for the cell and at least one of a numerology and coverage level. The instructions are further able to perform the step of applying a timing adjustment based on the determined timing adjustment delay parameter.

Certain embodiments of the present disclosure may provide one or more technical advantages. As an example, certain embodiments include adaptively determining at least one delay related to a cell and/or beam setup/release procedure based on the numerology of the cell. Particular embodiments may reduce the complexity of the base station receiver receiving signals from the UE on two or more serving cells. Furthermore, for TAGs where any serving cells may be included in the TAG, base station performance may degrade if the base station uses the same TA parameters for all cells in the TAG. Particular embodiments enhance base station performance for such TAGs. Other advantages will be apparent to persons of ordinary skill in the art.

### BRIEF DESCRIPTION OF THE DRAWINGS

For a more complete understanding of the embodiments and their features and advantages, reference is now made to the following description, taken in conjunction with the accompanying drawings, in which:

FIG. 1 is a block diagram illustrating an example 5G architecture;

FIGS. 2A and 2B are block diagrams illustrating example 5G deployments;

FIG. 3 illustrates example carrier spacings with respect to the frequency and cell range;

FIG. 4 is a block diagram illustrating an example wireless network, according to a particular embodiment;

FIG. 5 is a flow diagram of an example method in a user equipment, according to some embodiments;

FIG. 6 is a flow diagram of an example method in a network node, according to some embodiments;

FIG. 7A is a block diagram illustrating an example embodiment of a wireless device;

FIG. 7B is a block diagram illustrating example components of a wireless device;

FIG. 8A is a block diagram illustrating an example embodiment of a network node; and

FIG. 8B is a block diagram illustrating example components of a network node.

### DETAILED DESCRIPTION

Certain embodiments of the present disclosure provide for adapting timing adjustment delay based on attributes of a particular cell. Additional details of certain embodiments are further described in the example scenarios below.

In some embodiments, a non-limiting term “UE” is used. The UE herein can be any type of wireless device capable of communicating with network node or another UE over radio signals. The UE may also be radio communication device, target device, device to device (D2D) UE, machine type UE or UE capable of machine to machine communication (M2M), a sensor equipped with UE, iPAD, Tablet, mobile terminals, smart phone, laptop embedded equipped (LEE), laptop mounted equipment (LME), USB dongles, Customer Premises Equipment (CPE), etc.

Also, in some embodiments generic terminology “network node” is used. A network node include any kind of network node which may comprise a radio network node such as base station, radio base station, base transceiver station, base station controller, network controller, gNB, NR BS, evolved Node B (eNB), Node B, Multi-cell/multicast

Coordination Entity (MCE), relay node, access point, radio access point, Remote Radio Unit (RRU) Remote Radio Head (RRH), a multi-standard BS (a.k.a. MSR BS), a core network node (e.g., MME, SON node, a coordinating node, positioning node, MDT node, etc.), or even an external node (e.g., 3rd party node, a node external to the current network), etc. The network node may also comprise a test equipment.

The term “radio node” used herein may be used to denote a UE or a radio network node.

The embodiments are applicable to single carrier as well as to multicarrier or carrier aggregation (CA) operation of the UE in which the UE is able to receive and/or transmit data to more than one serving cells. Carrier aggregation (CA) may also be referred to as “multi-carrier system”, “multi-cell operation”, “multi-carrier operation”, “multi-carrier” transmission and/or reception. In CA, one of the component carriers (CCs) is the primary component carrier (PCC) or simply primary carrier or even anchor carrier. The remaining carrier may be referred to as secondary component carrier (SCC) or simply secondary carriers or even supplementary carriers. The serving cell may interchangeably be referred to as primary cell (PCell) or primary serving cell (PSC). Similarly, the secondary serving cell may interchangeably be referred to as secondary cell (SCell) or secondary serving cell (SSC).

The term “signaling” used herein may comprise any of: high-layer signaling (e.g., via RRC or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “time resource” used herein may correspond to any type of physical resource or radio resource expressed in terms of length of time. Examples of time resources include: symbol, time slot, subframe, radio frame, TTI, interleaving time, etc.

The term “flexible numerology” used herein may refer, for example, to any one or more of: subcarrier spacing, number of subcarriers per RB, number of RBs within the bandwidth, etc., which can be configured in a flexible way.

The term “radio measurement” used herein may refer to any measurement performed on radio signals. Radio measurements can be absolute or relative. Radio measurements can be, for example, intra-frequency, inter-frequency, CA, etc. Radio measurements can be unidirectional (e.g., downlink or uplink) or bidirectional (e.g., RTT, Rx-Tx, etc.). Some examples of radio measurements include: timing measurements (e.g., TOA, timing advance, RTT, RSTD, SSTD, Rx-Tx, propagation delay, etc.), angle measurements (e.g., angle of arrival), power-based measurements (e.g., received signal power, RSRP, received signal quality, RSRQ, SINR, SNR, CSI, CQI, PMI, interference power, total interference plus noise, RSSI, noise power, etc.), cell detection or identification, beam detection or beam identification, system information reading, RLM, CSI, CQI, PMI, etc.

The term “timing adjustment delay” with regard to NR refers to the delay between reception of a command or request to adjust a timing of uplink transmissions and the point in time when the adjusted timing is applied. The NR timing adjustment delay may be independent of an LTE timing adjustment delay.

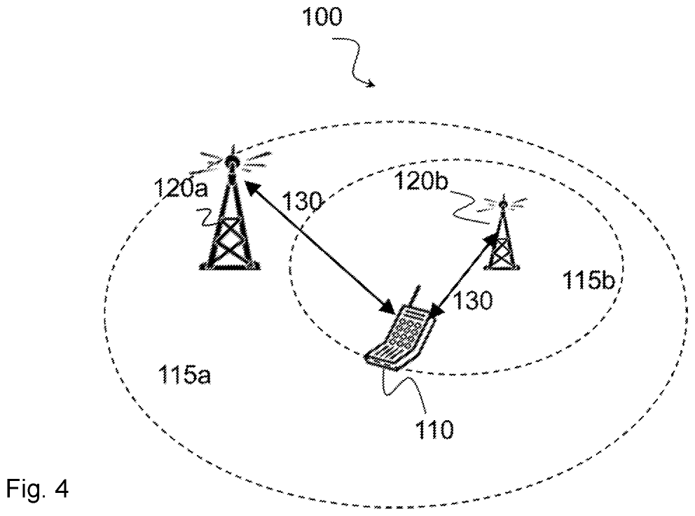

Particular embodiments are described with reference to FIGS. 4-8B of the drawings, like numerals being used for like and corresponding parts of the various drawings. LTE and NR are used throughout this disclosure as example cellular systems, but the ideas presented herein may apply to other wireless communication systems as well.

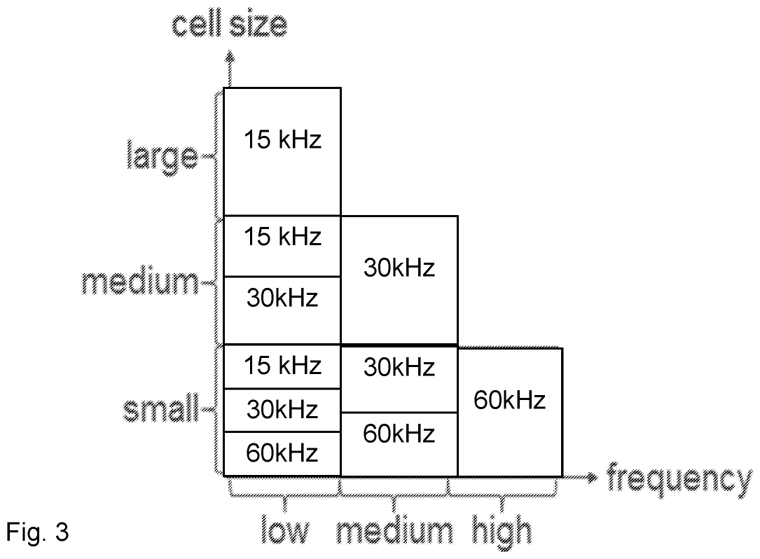

FIG. 3 is a block diagram illustrating an example wireless network, according to a particular embodiment. Wireless network 100 includes one or more wireless devices 110 (such as mobile phones, smart phones, laptop computers, tablet computers, MTC devices, or any other devices that can provide wireless communication) and a plurality of network nodes 120 (such as base stations or eNodeBs). Network node 120 serves coverage area 115 (also referred to as cell 115).

In general, wireless devices 110 that are within coverage of radio network node 120 (e.g., within cell 115 served by network node 120) communicate with radio network node 120 by transmitting and receiving wireless signals 130. For example, wireless devices 110 and radio network node 120 may communicate wireless signals 130 containing voice traffic, data traffic, and/or control signals. A network node 120 communicating voice traffic, data traffic, and/or control signals to wireless device 110 may be referred to as a serving network node 120 for the wireless device 110. Wireless signals 130 may be transmitted according to a particular numerology (e.g., radio frame duration, subframe or TTI duration, slot duration, symbols per slot and subframe, subcarrier spacing, sampling frequency, FFT size, subcarriers per resource block, cyclic prefix, etc.).

In some embodiments, wireless device 110 may be referred to by the non-limiting term “UE.” A UE may include any type of wireless device capable of communicating with a network node or another UE over radio signals. The UE may comprise radio communication device, target device, device to device (D2D) UE, machine type UE or UE capable of machine to machine communication (M2M), a sensor equipped with UE, iPAD, Tablet, mobile terminals, smart phone, laptop embedded equipped (LEE), laptop mounted equipment (LME), USB dongles, Customer Premises Equipment (CPE), etc.

In some embodiments, network node 120 may include any type of network node such as a base station, radio base station, base transceiver station, base station controller, network controller, evolved Node B (eNB), Node B, multi-RAT base station, Multi-cell/multicast Coordination Entity (MCE), relay node, access point, radio access point, Remote Radio Unit (RRU) Remote Radio Head (RRH), a core network node (e.g., MME, SON node, a coordinating node, etc.), or even an external node (e.g., 3rd party node, a node external to the current network), etc.

Wireless signals 130 may include both downlink transmissions (from radio network node 120 to wireless devices 110) and uplink transmissions (from wireless devices 110 to radio network node 120).

Each network node 120 may have a single transmitter or multiple transmitters for transmitting wireless signals 130 to wireless devices 110. In some embodiments, network node 120 may comprise a multi-input multi-output (MIMO) system. Similarly, each wireless device 110 may have a single receiver or multiple receivers for receiving signals 130 from network nodes 120.

Network 100 may include carrier aggregation. For example, wireless device 110 may be served by both network node 120a and 120b and communicate wireless signals 130 with both network node 120a and 120b.

In particular embodiments, each network node 120 may support a different numerology. Wireless devices 110 and network nodes 120 may exchange numerology information with each other so that wireless device 110 may communicate with various network nodes 120.

Wireless device 110 and network node 120 may adapt timing advance parameters, such as a timing adjustment delay parameter, to account for different numerologies. For example, a radio node such as wireless device 110 or network node 120 may obtain information about timing adjustment for a cell, such as cell 115. The obtained information comprises at least one of a numerology and coverage level.

In some embodiments, the obtained information may also include at least one of an amount of timing adjustment; a timing adjustment delay; one or more parameters characterizing a reference with respect to which the timing adjustment is to apply; one or more parameters characterizing the timing adjustment including at least one of step size, frequency of the timing update, and maximum allowed adjustment; an indication of one or more links or a group of links for which the timing adjustment can be applied; and at least one of a carrier frequency, cell size, and cell range.

The one or more parameters characterizing the reference with respect to which the timing adjustment is to apply may include at least one of a cell, a downlink or uplink link, a downlink or uplink time unit, a downlink or uplink transmission, a downlink or uplink signal, a reference numerology, a reference time or frequency resource, and a reference subband. The indication of the one or more links or the group of links for which the timing adjustment can be applied may include at least one of one or more cells, a TAG, and a TRP associated with a link.

In some embodiments, wireless device 110 or network node 120 may obtain information about timing adjustment for cell 115 by: receiving a message from another node (such as wireless device 110 receiving a message from network node 120, or network node 120a receiving a message from network node 120b, etc.); obtaining a predefined value, table, mapping, function, or rule; measuring a radio signal; obtaining a coverage characterization; obtaining a CA configuration and TAG of a wireless device 110 or network node 120; and obtaining a numerology used for a particular link or group of links.

In some embodiments, wireless device 110 may use carrier aggregation with cells 115a and 115b. Obtaining information about the numerology may comprise obtaining a reference numerology. For example, cell 115b may have a larger subcarrier spacing than cell 115a. In some embodiments, the numerology of the cell with the largest subcarrier spacing may be used as the reference numerology. In some embodiments, the cell with the smallest or median subcarrier spacing may be used as the reference numerology.

Wireless device 110 or network node 120 may determine a timing adjustment delay parameter for transmissions on cell 115 based on the obtained information about timing adjustment for cell 115. For example, wireless device 110 or network node 120 may: determine a delay measured in an absolute time unit, measured in a radio time unit, or specified by a particular time resource; determine a delay based on a predefined value, table, mapping, function, or rule; determine a delay based on a radio measurement; and determine a delay based on history.

In some embodiments, the predefined rule comprises at least one of: a shorter timing adjustment delay for a larger subcarrier spacing in uplink; a shorter timing adjustment delay for a larger subcarrier spacing in downlink; a shorter timing adjustment delay for a larger subcarrier spacing which is the largest or the smallest among downlink and uplink; a shorter delay for a smaller cell; a shorter delay when a radio measurement is below a threshold; a shorter delay for a cell bandwidth above a threshold; a shorter delay for a channel condition above a threshold; and a first delay for normal conditions and a second delay for extreme conditions.

In particular embodiments, wireless device 110 or network node 120 may apply a timing adjustment based on the determined timing adjustment delay parameter. Applying the timing adjustment comprises updating a timing parameter, a timer, or a counter associated with one or more transmissions of wireless device 110.

In particular embodiments, wireless device 110 may apply the timing adjustment within a timing adjustment delay period determined based on the timing adjustment delay parameter, or within a particular time resource determined based on the timing adjustment delay parameter. Wireless device 110 may transmit a radio transmission to network node 120 according to the applied timing adjustment.

In particular embodiments, network node 120 may send the determined timing adjustment delay parameter to wireless device 110. Network node 120 may receive a radio transmission from wireless device 110 according to the applied timing adjustment.

In wireless network 100, each radio network node 120 may use any suitable radio access technology, such as long term evolution (LTE), LTE-Advanced, NR, UMTS, HSPA, GSM, cdma2000, WiMax, WiFi, and/or other suitable radio access technology. Wireless network 100 may include any suitable combination of one or more radio access technologies. For purposes of example, various embodiments may be described within the context of certain radio access technologies. However, the scope of the disclosure is not limited to the examples and other embodiments could use different radio access technologies.

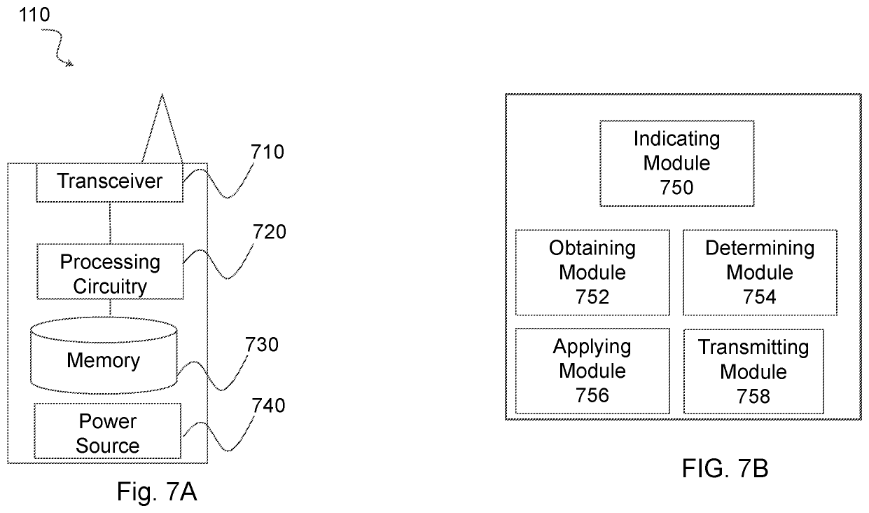

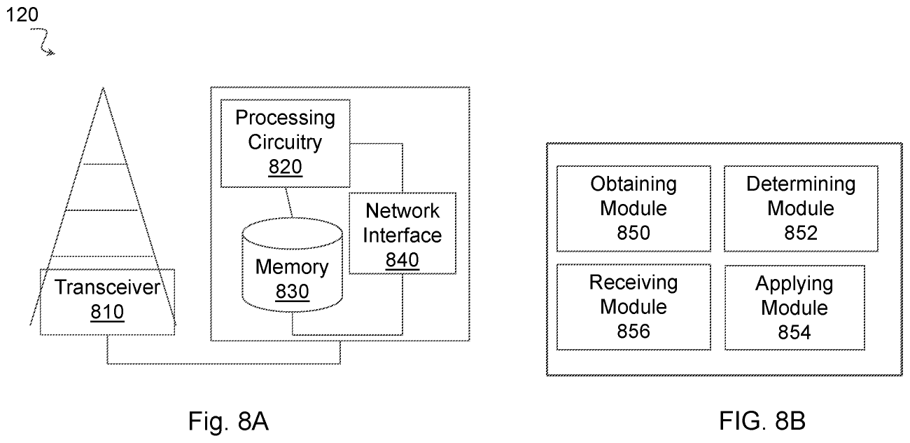

As described above, embodiments of a wireless network may include one or more wireless devices and one or more different types of radio network nodes capable of communicating with the wireless devices. The network may also include any additional elements suitable to support communication between wireless devices or between a wireless device and another communication device (such as a landline telephone). A wireless device may include any suitable combination of hardware and/or software. For example, in particular embodiments, a wireless device, such as wireless device 110, may include the components described below with respect to FIG. 7A. Similarly, a network node may include any suitable combination of hardware and/or software. For example, in particular embodiments, a network node, such as network node 120, may include the components described below with respect to FIG. 8A.

Generally, a method in a radio node (e.g., wireless device, terminal, UE, network node, base station, eNodeB, etc.) may comprise any of the following steps. A first step includes indicating to another radio node a first radio node's capability related to controlling the timing adjustment delay adaptively to one or more of: numerology (e.g., in a downlink link with received TA and in an uplink link with the uplink transmission for which TA should apply), coverage level, cell range, carrier frequency (e.g., of the downlink link with received TA and/or of the uplink link with the uplink transmission for which TA should apply), measurement, threshold, and/or condition.

A second step includes obtaining information about timing adjustment. A third step includes determining a timing adjustment delay and/or one or more parameters related to the timing adjustment delay adaptively to one or more of: numerology (e.g., in a downlink link with received TA and in an uplink link with the uplink transmission for which TA should apply), coverage level, cell range, carrier frequency (e.g., of the downlink link with received TA and/or of the uplink link with the uplink transmission for which TA should apply), measurement, threshold, and/or condition.

A fourth step includes applying the timing adjustment, based on the determined timing adjustment delay or the parameter(s). A fifth step includes performing one or more transmissions based on the applied timing adjustment.

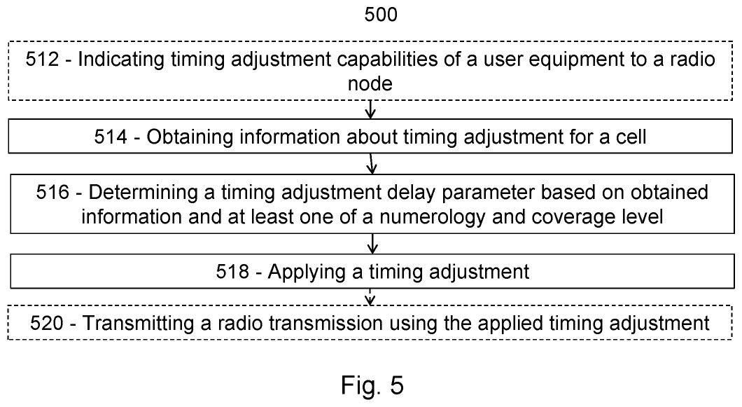

Examples of timing adjustment include: timing advance, UE-controlled and/or network-controlled timing adjustment, etc. Examples of coverage may include downlink and/or uplink coverage area. Examples of cell range may include downlink and/or uplink cell range. Measurements may include any of the measurement described above. A particular example method is illustrated in FIG. 5.

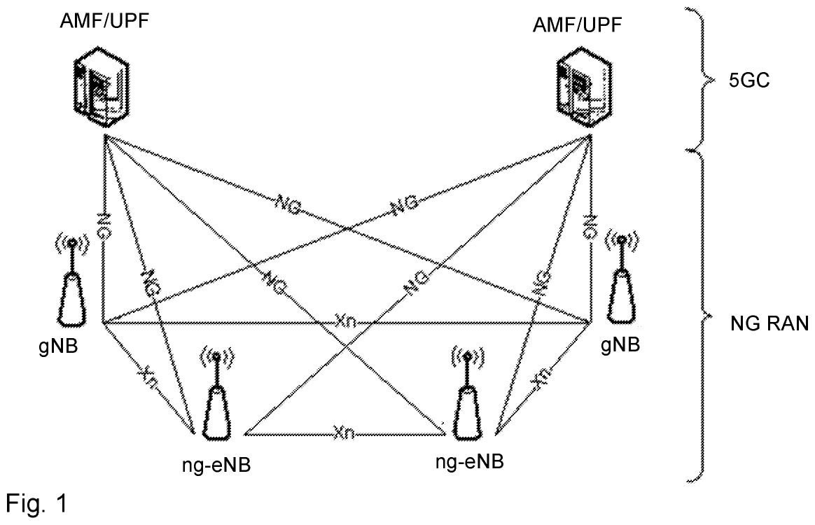

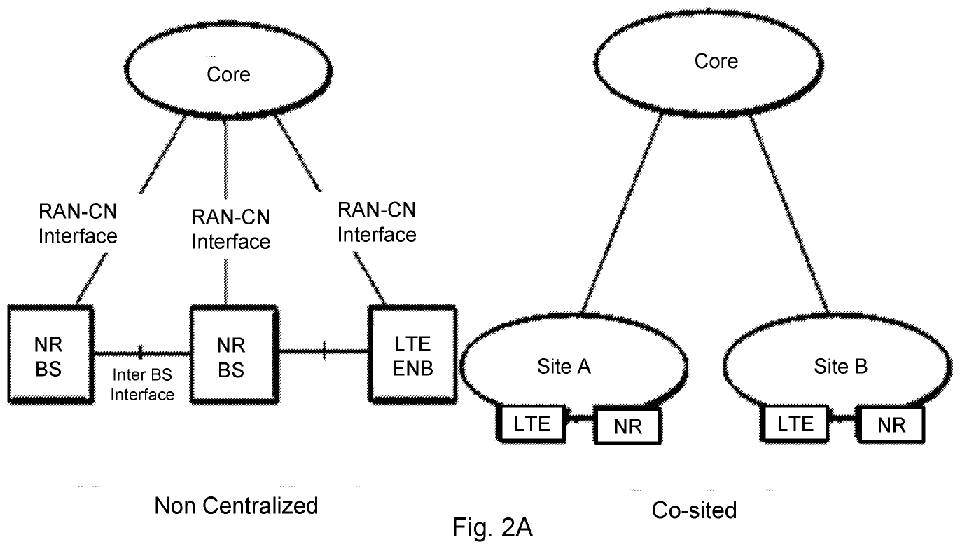

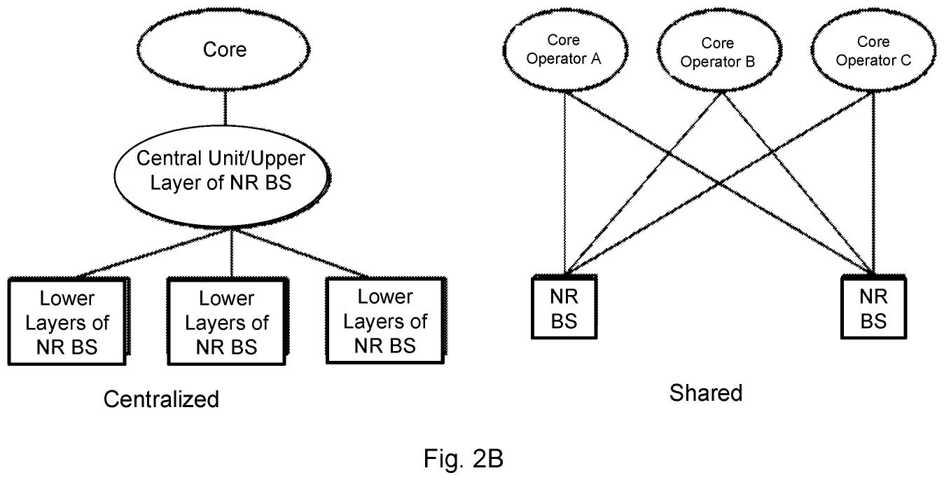

FIG. 5 is a flow diagram of an example method in a user equipment, according to some embodiments. In particular embodiments, one or more steps of method 500 may be performed by components of wireless network 100 described with reference to FIGS. 1-8B. Method 500 may adapt a timing adjustment delay parameter.

The method begins at step 512, where in some embodiments, the radio node indicates its timing adjustment capabilities to another radio node. In particular embodiments, the radio node may indicate to another node (e.g., the controlling node or to another node such as another radio network node, core network node, positioning node, etc.) the radio node's capability related to controlling the timing adjustment delay adaptively to one or more of: numerology, coverage level, cell range, measurement, carrier frequency, threshold or condition.

As a particular example, wireless device 110 may indicate its timing adjustment capabilities to network node 120a, network node 120b, or another wireless device 110. In particular embodiments, the capability may be sent upon a request from another node or in an unsolicited way (e.g., upon triggering event, condition, receiving a message from another node, etc.).

At step 514, the radio node obtains information about timing adjustment for a cell. For example wireless device 110 may obtain information about timing adjustment for cell 115a.

In particular embodiments, the information about timing adjustment may comprise, e.g., one or more of: (a) amount of timing adjustment (absolute or relative with respect to a reference such as a downlink reference or previous uplink transmission); (b) timing adjustment delay; (c) one or more parameters characterizing a reference with respect to which the timing adjustment is to apply (e.g., a cell or a downlink or uplink link, a downlink or uplink time unit, a downlink or uplink transmission, a downlink or uplink signal, a reference numerology, a reference time and/or frequency resource, a reference subband, etc.) for example, a timing adjustment applies with respect to a downlink time unit determined by received specific downlink signal/channel using a reference numerology in a reference subband; (d) one or more parameters characterizing timing adjustment (e.g., step size, frequency of the timing update, maximum allowed adjustment, etc.); (e) an indication of one or more links or a group of links for which the timing adjustment can be applied (e.g., one or more cells, a TAG, TRP associated with a link, etc.); (f) one or more of: numerology(-ies), carrier frequency(-ies), coverage level(s), cell range(s) (e.g., small cell, pico cell, micro cell, macro cell or cell range characterized by a measurement such as smallest pathloss or maximum timing measurements), threshold(s), and conditions, for which the timing adjustment can be applied.

In particular embodiments, the obtaining may be based, for example, on a message or indication received from another node (e.g., from a controlling node), such as a TA command. The receiving may be via unicast, multicast or broadcast via higher-layer signaling and/or physical layer signaling. In one example, one or a set of applicable timing adjustment delays or delay-related parameter(s) may be received from another node; in case multiple options are provided, the radio node may select one in Step 516.

In some embodiments, the obtaining may be based on: (a) pre-defined value(s), table, mapping, function, or rule; (b) measurement performed by the radio node (e.g., a timing measurement or pathloss or received signal power measurement); (c) coverage characterization; (d) CA configuration and TAG of the radio node (e.g., for determining cells or links to which the timing adjustment will apply and determining the amount of timing adjustment); (e) numerology(-ies) used in one or more concerned links or a group of links (e.g., dowlink and/or uplink links), where in one example for a larger carrier spacing smaller but more frequent time adjustments may be considered.

As an example of a particular measurement, wireless device 110 may measure or detect a particular a beam or beam identification, system information, RLM, CSI, CSI-RS, CQI, PMI, etc.

In some embodiments, the obtaining may be further associated with a time resource R1, e.g., the timing resource in which the timing adjustment information was obtained. The obtaining may be further associated with a numerology NUM1, e.g., the numerology used in time resource R1.

At step 516, the radio node determines a timing adjustment delay parameter for transmissions on the cell based on the obtained information about timing adjustment for the cell and at least one of a numerology and coverage level. For example, wireless device 110 may determine a timing adjustment delay parameter for transmissions on cell 115a based on the obtained information about timing adjustment for cell 115a.

In particular embodiments, the radio node may determine the applicable timing adjustment delay and/or one or more parameters related to the timing adjustment delay, adaptively to one or more of: numerology (e.g., in downlink with received TA and in uplink with the uplink transmission for which TA should apply), coverage level, cell range, carrier frequency (e.g., of the downlink with received TA and/or of the uplink with the uplink transmission for which TA should apply), measurement, threshold, condition.

In some embodiments, the delay may be measured in absolute time units (e.g., ms). In some embodiments, the delay may be measured in radio time units (e.g., subframes, slots, symbols, etc.). In one embodiment, when numerology N1 has corresponding subcarrier spacing SC1 and time unit (e.g., subframe) length T1, and numerology N2 has corresponding subcarrier spacing SC2=SC1(2\hat{ }n) or SC2=SC1*(2\hat{ }n), the time unit (e.g., subframe) length T2=T1*n and T2=T1/n respectively, the timing adjustment delay D2 is not obtained by the exact scaling of D1, e.g., D2 may include an additional term which may not exactly scale with n e.g. D2=f(D1,n)+Δ.

In particular embodiments, the determining may comprise determining a specific time resource R2 where the timing adjustment is to be applied. In one example, the timing adjustment delay counting may be in time units of the concerned uplink link. In another example, the determining of the time resource R2 may also comprise converting from the delay measured in absolute time units (e.g., ms) to the radio time units of the concerned uplink link. In yet another example, when the numerology is dynamic, the delay may be measured in absolute time units (e.g., ms) and then mapped directly to R2, without converting into radio time units since the latter may have different lengths. In yet another example, the timing adjustment delay may be counted in reference time units (e.g., subframes of 1 ms), even if a different numerology is used (e.g., corresponding to a shorter subframe length).

In particular embodiments, determining may comprise determining of one or more criteria: numerology, coverage level, cell range, carrier frequency, measurement, threshold, condition. The determining may be based, for example, on one or more of: (a) message or indication received from another node (e.g., in Step 514); (b) pre-defined values or tables; (c) pre-defined rule/mapping/table/function (e.g., for selecting from a set or for determining/calculating, etc.); (c) selection from a set of delay options (e.g., pre-defined set or a set provided by another node); (d) measurements (e.g., blind detection of numerology and then mapping the determined numerology to the corresponding delay; determining a coverage level based on RSRP or pathloss or timing measurement and then use the measurements for mapping to the timing adjustment delay); and (e) history (e.g., the latest used).

An example of a rule for determining the applicable timing adjustment delay may include determining based on a function or mapping of the numerology used in uplink of the concerned link and/or in downlink (e.g., reference downlink link), e.g., more generally f(NUM_DL) or f(NUM_UL) or f(NUM_DL, NUM_UL). Particular examples may include: (a) shorter timing adjustment delay for a larger subcarrier spacing in uplink; (b) shorter timing adjustment delay for a larger subcarrier spacing in downlink; (c) shorter timing adjustment delay for a larger subcarrier spacing which is the largest or the smallest among downlink and uplink; (d) timing adjustment delay is not shorter than the length of N (e.g., N=1,2, . . .) time units (e.g., subframe) corresponding to the numerology in downlink, for example, because a reference time units may need to be fully received before the timing adjustment takes place.

When multiple numerologies are used in uplink of the concerned link and/or downlink, the determining may be based on a function of the multiple numerologies or of a reference numerology (e.g., which is selected from the multiple numerologies based on a rule such as the numerology with the largest subcarrier spacing and/or the numerology used the most in the link or over at least X % of time). Determining may be based on coverage level and/or cell range (e.g., shorter delay in smaller cells or for a coverage level closer to the associated BS). Determining may be based on measurements (e.g., a shorter delay be selected when RSRP is above a threshold or pathloss is below a threshold and timing measurement is below another threshold).

When the timing adjustment is to apply for two or more cells or links using different numerologies, the determining may be based on a reference numerology (e.g., configured by another node or selected based on a rule e.g. corresponding to the largest subcarrier spacing among the two or more cells/links or corresponding to the smallest subcarrier spacing among the two or more cells/links).

Determining based on conditions may comprise determining depending, e.g.,: (a) bandwidth (e.g., shorter delay for a bandwidth above a threshold); (b) channel condition (e.g., shorter delay for a channel condition above a threshold, where a channel condition may be represented by signal strength, signal quality, channel state indication, etc.); and (c) environmental condition (e.g., delay D1 in normal conditions and D2 in extreme conditions). In particular embodiments, any of the above rules may be combined in any suitable combination.

At step 518, the radio node applies a timing adjustment based on the determined timing adjustment delay. For example, wireless device 110 applies a timing adjustment based on the determined timing adjustment delay.

In particular embodiments, the applying may comprise (re)starting or updating a timing parameter, a timer (e.g., TA timer) or a counter associated with one or more transmissions of the radio node.

The applying may also comprise adjusting timing for one or more cells or links comprised in a group. In one embodiment, the one or more cells or links may be characterized by one or more of: using the same or similar (e.g., subcarrier spacing is below a first threshold and/or above a second threshold) numerology, same or similar coverage level with respect to the radio node, same or similar measurement results (e.g., timing or pathloss, etc.), etc.

The applying of the timing adjustment based on the determined timing adjustment delay may comprise, for example, any of applying the timing adjustment within the determined delay or not later than the determined delay; and applying the timing adjustment in a specific time resource R2 determined by the delay.

At step 520, the radio node, in some embodiments, may perform a radio transmission using the applied timing adjustment. For example, wireless device 110 performs a radio transmission using the applied timing adjustment. In particular embodiments, one or more transmissions may be via one or more links (e.g., in one or more cells within a group of cells such as a TAG).

Modifications, additions, or omissions may be made to method 500 illustrated in FIG. 5. Additionally, one or more steps in method 500 may be performed in parallel or in any suitable order.

Generally, methods in a controlling node, such as a network node, comprise the following steps. At a first step, receiving from a radio node an indication about the radio node's capability related to controlling the timing adjustment delay adaptively to one or more of: numerology (e.g., in a downlink link with received TA and in an uplink link with the uplink transmission for which TA should apply), coverage level, cell range, carrier frequency (e.g., of the downlink link with received TA and/or of the uplink link with the uplink transmission for which TA should apply), measurement, threshold, and/or condition.

A second step includes obtaining the information about timing adjustment. A third step includes determining a timing adjustment delay and/or one or more parameters related to the timing adjustment delay adaptively to one or more of: numerology (e.g., in a downlink link with received TA and in an uplink link with the uplink transmission for which TA should apply), coverage level, cell range, carrier frequency (e.g., of the downlink link with received TA and/or of the uplink link with the uplink transmission for which TA should apply), measurement, threshold, and/or condition.

A fourth step includes sending the determined timing adjustment delay parameter to the radio node. A fifth step includes receiving one or more transmissions of the radio node, transmitted based on the controlled timing adjustment delay.

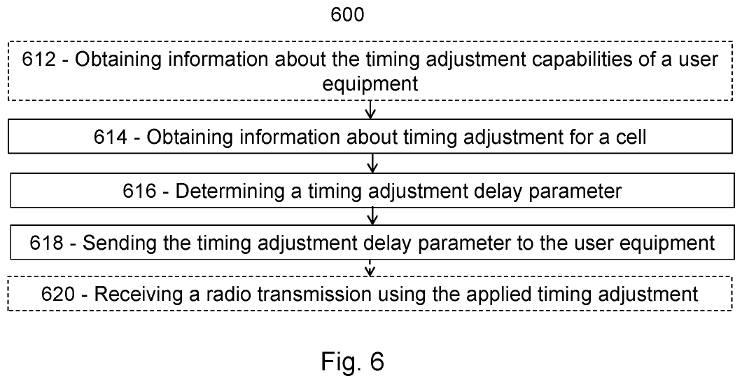

Examples of the controlling node include: another UE, radio network node, radio network controller, core network node, etc. A particular example method is illustrated in FIG. 6.

FIG. 6 is a flow diagram of an example method in a controlling node, according to some embodiments. In particular embodiments, one or more steps of method 600 may be performed by components of wireless network 100 described with reference to FIGS. 1-8B. Method 600 may adapt a timing adjustment delay parameter.

The method begins at step 612, where in some embodiments, the controlling node obtains information about the timing adjustment capabilities of the radio node. For example, network node 120a may obtain information about the timing adjustment capabilities of wireless device 110.

In particular embodiments, the controlling node may obtain the information about the radio node's capability related to controlling the timing adjustment delay adaptively to one or more of: numerology (e.g., in downlink link with received TA and in uplink link with the uplink transmission for which TA should apply), coverage level, cell range, carrier frequency (e.g., of the downlink link with received TA and/or of the uplink link with the uplink transmission for which TA should apply), measurement, threshold, condition.

In some embodiments, the obtaining may be receiving from the radio node or from another node. The controlling node may send a request for the capability information. In some embodiments, the obtaining may be based on pre-defined rules or measurements on the radio node's transmissions or observing radio node's behavior or history.

At step 614, the controlling node obtains information about timing adjustment for a cell. For example, network node 120a may obtain information about timing adjustment for cell 115a or cell 115b. In particular embodiments, methods of obtaining may be similar to those described with respect to FIG. 5 for the radio node.

At step 616, the controlling node determines a timing adjustment delay parameter for transmissions on the cell based on the obtained information about timing adjustment for the cell and at least one of a numerology and coverage level. For example, network node 120a may determine a timing adjustment delay parameter for transmissions on cell 115a or 115b based on the obtained information about timing adjustment for cell 115a or 115b, respectively, or in combination.

In particular embodiments, the controlling node may control the timing adjustment delay and/or one or more parameters related to the timing adjustment delay, adaptively to one or more of: numerology (e.g., in downlink link with received TA and in uplink link with the uplink transmission for which TA should apply), coverage level, cell range, carrier frequency (e.g., of the downlink link with received TA and/or of the uplink link with the uplink transmission for which TA should apply), measurement, threshold, and condition.

In particular embodiments, the controlling may comprise obtaining or determining the timing adjustment delay and/or one or more parameters related to the timing adjustment delay. Methods for obtaining and determining may be similar to those described with respect to FIG. 5 for the radio node.

At step 618, the controlling node sends the determined timing adjustment delay parameter to the radio node. For example, network node 120a may send the determined timing adjustment delay parameter to wireless device 110.

In particular embodiments, the controlling may comprise sending or indicating to the radio node the applicable timing adjustment delay and/or one or more parameters related to the timing adjustment delay to enable the radio node to determine the timing adjustment delay it should apply.

At step 620, in some embodiments, the controlling node receives a radio transmission from the radio node using the applied timing adjustment. For example, network node 120a may receive one or more transmissions from wireless device 110, transmitted based on the controlled timing adjustment delay.

Modifications, additions, or omissions may be made to method 600 illustrated in FIG. 6. Additionally, one or more steps in method 600 may be performed in parallel or in any suitable order.

FIG. 7A is a block diagram illustrating an example embodiment of a wireless device. The wireless device is an example of the wireless devices 110 illustrated in FIG. 4. In particular embodiments, the wireless device is capable of adapting a timing adjustment delay parameter of network 100. For example, wireless device 110 may obtain information about timing adjustment for a cell; determine a timing adjustment delay parameter for transmissions on the cell based on the obtained information about timing adjustment for the cell; and apply a timing adjustment based on the determined timing adjustment delay parameter.

Particular examples of a wireless device include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, a NB-IoT device, or any other device that can provide wireless communication. The wireless device includes transceiver 710, processor 720, and memory 730. In some embodiments, transceiver 710 facilitates transmitting wireless signals to and receiving wireless signals from wireless network node 120 (e.g., via an antenna), processor 720 executes instructions to provide some or all of the functionality described herein as provided by the wireless device, and memory 730 stores the instructions executed by processor 720.

Processor 720 includes any suitable combination of hardware and software implemented in one or more integrated circuits or modules to execute instructions and manipulate data to perform some or all of the described functions of the wireless device. In some embodiments, processor 720 may include, for example, one or more computers, one more programmable logic devices, one or more central processing units (CPUs), one or more microprocessors, one or more applications, and/or other logic, and/or any suitable combination of the preceding. Processor 720 may include analog and/or digital circuitry configured to perform some or all of the described functions of wireless device 110. For example, processor 720 may include resistors, capacitors, inductors, transistors, diodes, and/or any other suitable circuit components.

Memory 730 is generally operable to store computer executable code and data. Examples of memory 730 include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or or any other volatile or non-volatile, non-transitory computer-readable and/or computer-executable memory devices that store information.

In particular embodiments, processor 720 in communication with transceiver 710 communicates wireless signals with radio network node 120 or other wireless devices 110. In particular embodiments, processor 720 in communication with transceiver 710 may adapt timing adjustment delay for transmissions with one or more network nodes 120. Other embodiments of the wireless device may include additional components (beyond those shown in FIG. 7A) responsible for providing certain aspects of the wireless device's functionality, including any of the functionality described above and/or any additional functionality (including any functionality necessary to support the solution described above).

FIG. 7B is a block diagram illustrating example components of a wireless device 110. The components may include indicating module 750, obtaining module 752, determining module 754, applying module 756, and transmitting module 758.

Indicating module 750 may perform the indicating functions of wireless device 110. For example, indicating module 750 may perform the indicating steps (e.g., step 512) described with respect to FIG. 5. In certain embodiments, indicating module 750 may include or be included in processor 720. In particular embodiments, indicating module 750 may communicate with obtaining module 752, determining module 754, applying module 756, and transmitting module 758.

Obtaining module 752 may perform the obtaining functions of wireless device 110. For example, obtaining module 752 may provide the obtaining steps (e.g., step 514) described with respect to FIG. 5. In certain embodiments, obtaining module 752 may include or be included in processor 720. In particular embodiments, obtaining module 752 may communicate with indicating module 750, determining module 754, applying module 756, and transmitting module 758.

Determining module 754 may perform the determining functions of wireless device 110. For example, determining module 754 may perform the determining tasks (e.g., step 516) described with respect to FIG. 5. In certain embodiments, determining module 754 may include or be included in processor 720. In particular embodiments, determining module 754 may communicate with indicating module 750, obtaining module 752, applying module 756, and transmitting module 758.

Applying module 756 may perform the applying functions of wireless device 110. For example, applying module 756 may perform the applying tasks (e.g., step 518) described with respect to FIG. 5. In certain embodiments, applying module 756 may include or be included in processor 720. In particular embodiments, applying module 756 may communicate with indicating module 750, obtaining module 752, determining module 754, and transmitting module 758.

Transmitting module 758 may perform the transmitting functions of wireless device 110. For example, transmitting module 758 may perform the transmitting tasks (e.g., step 520) described with respect to FIG. 5. In certain embodiments, transmitting module 758 may include or be included in processor 720. In particular embodiments, applying module 756 may communicate with indicating module 750, obtaining module 752, determining module 754, and applying module 756.

FIG. 8A is a block diagram illustrating an example embodiment of a network node. The network node is an example of the network node 120 illustrated in FIG. 4. In particular embodiments, the network node is capable of adapting a timing adjustment delay parameter of network 100. For example, network node 120 may obtain information about timing adjustment for a cell; determine a timing adjustment delay parameter for transmissions on the cell based on the obtained information about timing adjustment for the cell; and apply a timing adjustment based on the determined timing adjustment delay parameter.

Network node 120 can be an eNodeB, a nodeB, a base station, a wireless access point (e.g., a Wi-Fi access point), a low power node, a base transceiver station (BTS), a transmission point or node, a remote RF unit (RRU), a remote radio head (RRH), or other radio access node. Network node 120 includes at least one transceiver 810, at least one processor 820, at least one memory 830, and at least one network interface 840. Transceiver 810 facilitates transmitting wireless signals to and receiving wireless signals from a wireless device, such as wireless devices 110 (e.g., via an antenna); processor 820 executes instructions to provide some or all of the functionality described above as being provided by a network node 120; memory 830 stores the instructions executed by processor 820; and network interface 840 communicates signals to backend network components, such as a gateway, switch, router, Internet, Public Switched Telephone Network (PSTN), controller, and/or other network nodes 120. Processor 820 and memory 830 can be of the same types as described with respect to processor 720 and memory 730 of FIG. 7A above.

In some embodiments, network interface 840 is communicatively coupled to processor 820 and refers to any suitable device operable to receive input for network node 120, send output from network node 120, perform suitable processing of the input or output or both, communicate to other devices, or any combination of the preceding. Network interface 840 includes appropriate hardware (e.g., port, modem, network interface card, etc.) and software, including protocol conversion and data processing capabilities, to communicate through a network.

In particular embodiments, processor 820 in communication with transceiver 810 may adapt timing adjustment delay parameters with other network nodes 120 and/or with wireless devices 110.

Other embodiments of network node 120 include additional components (beyond those shown in FIG. 8A) responsible for providing certain aspects of the network node's functionality, including any of the functionality described above and/or any additional functionality (including any functionality necessary to support the solution described above).

The various different types of radio network nodes may include components having the same physical hardware but configured (e.g., via programming) to support different radio access technologies, or may represent partly or entirely different physical components.

FIG. 8B is a block diagram illustrating example components of a network node 120. The components may include obtaining module 850, determining module 852, applying module 854, and receiving module 856.

Obtaining module 850 may perform the obtaining functions of network node 120. For example, obtaining module 850 may perform the obtaining steps (e.g., steps 612 and 614) described with respect to FIG. 6. In certain embodiments, obtaining module 850 may include or be included in processor 820. In particular embodiments, obtaining module 850 may communicate with determining module 852, applying module 854, and receiving module 856.

Determining module 852 may perform the determining functions of network node 120. For example, determining module 852 may provide the determining steps (e.g., step 616) described with respect to FIG. 6. In certain embodiments, determining module 852 may include or be included in processor 820. In particular embodiments, determining module 852 may communicate with obtaining module 850, applying module 854, and receiving module 856.

Applying module 854 may perform the applying functions of network node 120. For example, applying module 854 may provide the transmitting steps (e.g., step 618) described with respect to FIG. 6. In certain embodiments, applying module 854 may include or be included in processor 820. In particular embodiments, applying module 854 may communicate with obtaining module 850, determining module 852, and receiving module 856.

Receiving module 856 may perform the receiving functions of network node 120. For example, receiving module 856 may provide the receiving steps (e.g., step 620) described with respect to FIG. 6. In certain embodiments, receiving module 856 may include or be included in processor 820. In particular embodiments, receiving module 856 may communicate with obtaining module 850, determining module 852, and applying module 854.

The following list provides non-limiting examples of how certain aspects of the proposed solutions could be implemented. The examples are merely intended to illustrate how certain aspects of the proposed solutions could be implemented, however, the proposed solutions could also be implemented in other suitable manners. Examples include:

Radio node examples:

1. A method in a radio node for adapting timing advance parameters, the method comprising:

obtaining information about timing adjustment for a cell;

determining a timing adjustment delay parameter for transmissions on the cell based on the obtained information about timing adjustment for the cell; and

applying a timing adjustment based on the determined timing adjustment delay.

2. The method of example 1, further comprising indicating the timing adjustment capabilities of the radio node to another radio node.

3. The method of example 1, further comprising transmitting a radio transmission using the applied timing adjustment.

4. The method of example 1, wherein the obtained information about timing adjustment for the cell includes at least one of:

a.) an amount of timing adjustment;

b.) a timing adjustment delay;

c.) one or more parameters characterizing a reference with respect to which the timing adjustment is to apply including at least one of a cell or a downlink or uplink link, a downlink or uplink time unit, a downlink or uplink transmission, a downlink or uplink signal, a reference numerology, a reference time and/or frequency resource, and a reference subband;

d.) one or more parameters characterizing the timing adjustment including at least one of step size, frequency of the timing update, and maximum allowed adjustment;

e.) an indication of one or more links or a group of links for which the timing adjustment can be applied including at least one of one or more cells, a TAG, and a TRP associated with a link; and

f.) at least one of a numerology, carrier frequency, coverage level, small cell, pico cell, micro cell, macro cell, cell range characterized by a smallest pathloss or maximum timing measurement, threshold, and condition.

5. The method of example 1, wherein obtaining information about timing adjustment for the cell comprises at least one of:

a.) receiving a message from another radio node;

b.) obtaining a predefined value, table, mapping, function, or rule;

c.) measuring a radio signal;

d.) obtaining a coverage characterization;

e.) obtaining a CA configuration and TAG of the radio node; and

f.) obtaining a numerology used for a particular link or group of links.

6. The method of example 1, wherein determining the timing adjustment delay parameter comprises at least one of:

a.) determining a delay measured in an absolute time unit, measured in a radio time units, or a specified by a particular time resource;

b.) determining a delay based on a predefined value, table, mapping, function, or rule;

c.) determining a delay based on a radio measurement; and

d.) determining a delay based on history.

7. The method of example 6, wherein the predefined rule comprises at least one of:

a.) a shorter timing adjustment delay for a larger subcarrier spacing in uplink;

b.) a shorter timing adjustment delay for a larger subcarrier spacing in downlink;

c.) a shorter timing adjustment delay for a larger subcarrier spacing which is the largest or the smallest among downlink and uplink;

d.) a reference numerology selected from a plurality of numerologies;

e.) a shorter delay for a smaller cell;

f.) a shorter delay when a radio measurement is below a threshold;

g.) a shorter delay for a cell bandwidth above a threshold;

h.) a shorter delay for a channel condition above a threshold; and

i.) a first delay for normal conditions and a second delay for extreme conditions.

8. The method of example 1, wherein applying the timing adjustment comprises updating a timing parameter, a timer, or a counter associated with one or more transmissions of the radio node.

9. A radio node comprising a processor and a memory, the processor operable to perform any of the steps of examples 1-8.

10. A radio node configured to perform any of the methods of examples 1-8.

Controlling node examples:

1. A method in a controlling node for adapting timing advance parameters for a radio node, the method comprising:

obtaining information about timing adjustment for a cell;

determining a timing adjustment delay parameter for transmissions on the cell based on the obtained information about timing adjustment for the cell; and

sending the determined timing adjustment delay parameter to the radio node.

2. The method of example 1, further comprising obtaining information about the timing adjustment capabilities of the radio node.

3. The method of example 1, further comprising receiving a radio transmission from the radio node using the applied timing adjustment.

4. The method of example 1, wherein the obtained information about timing adjustment for the cell includes at least one of:

a.) an amount of timing adjustment;

b.) a timing adjustment delay;

c.) one or more parameters characterizing a reference with respect to which the timing adjustment is to apply including at least one of a cell or a downlink or uplink link, a downlink or uplink time unit, a downlink or uplink transmission, a downlink or uplink signal, a reference numerology, a reference time and/or frequency resource, and a reference subband;

d.) one or more parameters characterizing the timing adjustment including at least one of step size, frequency of the timing update, and maximum allowed adjustment;

e.) an indication of one or more links or a group of links for which the timing adjustment can be applied including at least one of one or more cells, a TAG, and a TRP associated with a link; and

f.) at least one of a numerology, carrier frequency, coverage level, small cell, pico cell, micro cell, macro cell, cell range characterized by a smallest pathloss or maximum timing measurement, threshold, and condition.

5. The method of example 1, wherein obtaining information about timing adjustment for the cell comprises at least one of:

a.) receiving a message from another radio node;

b.) obtaining a predefined value, table, mapping, function, or rule;

c.) measuring a radio signal;

d.) obtaining a coverage characterization;

e.) obtaining a CA configuration and TAG of the radio node; and

f.) obtaining a numerology used for a particular link or group of links.

6. The method of example 1, wherein determining the timing adjustment delay parameter comprises at least one of:

a.) determining a delay measured in an absolute time unit, measured in a radio time units, or a specified by a particular time resource;

b.) determining a delay based on a predefined value, table, mapping, function, or rule;

c.) determining a delay based on a radio measurement; and

d.) determining a delay based on history.

7. The method of example 6, wherein the predefined rule comprises at least one of:

a.) a shorter timing adjustment delay for a larger subcarrier spacing in uplink;

b.) a shorter timing adjustment delay for a larger subcarrier spacing in downlink;

c.) a shorter timing adjustment delay for a larger subcarrier spacing which is the largest or the smallest among downlink and uplink;

d.) a reference numerology selected from a plurality of numerologies;

e.) a shorter delay for a smaller cell;

f.) a shorter delay when a radio measurement is below a threshold;

g.) a shorter delay for a cell bandwidth above a threshold;

h.) a shorter delay for a channel condition above a threshold; and

i.) a first delay for normal conditions and a second delay for extreme conditions.

8. A controlling node comprising a processor and a memory, the processor operable to perform any of the steps of examples 1-7.

9. A controlling node configured to perform any of the methods of examples 1-7.

Some embodiments of the disclosure may provide one or more technical advantages. Some embodiments may benefit from some, none, or all of these advantages. Other technical advantages may be readily ascertained by one of ordinary skill in the art. Certain embodiments include adaptively determining at least one delay related to a cell and/or beam setup/release procedure based on the numerology of the cell. Particular embodiments may reduce the complexity of the base station receiver receiving signals from the UE on two or more serving cells. Particular embodiments enhance base station performance for TAGs with multiple cells comprising varying numerologies.

Although this disclosure has been described in terms of certain embodiments, alterations and permutations of the embodiments will be apparent to those skilled in the art. Although some embodiments have been described with reference to certain radio access technologies, any suitable radio access technology (RAT) or combination of radio access technologies may be used, such as long term evolution (LTE), LTE-Advanced, NR, UMTS, HSPA, GSM, cdma2000, WiMax, WiFi, etc. Accordingly, the above description of the embodiments does not constrain this disclosure. Other changes, substitutions, and alterations are possible without departing from the spirit and scope of this disclosure.

### ABBREVIATIONS

3GPP 3rd Generation Partnership Project
CA Carrier Aggregation
CC Component Carrier
D2D Device to Device
eNB Evolved Node B
eNodeB Evolved Node B
FDD Frequency Division Duplex
FFT Fast Fourier Transform
HSPA High Speed Packet Access
LTE Long-Term Evolution
M2M Machine to Machine
MBMS Multimedia Broadcast Multicast Service
NR New Radio
OFDM Orthogonal Frequency Division Multiplexing
PCC Primary Component Carrier
PCell Primary Cell
RAT Radio Access Technology
RB Resource Block
RRC Radio Resource Control
RSRP Reference Signal Received Power
RSRQ Reference Signal Received Quality
SCC Secondary Component Carrier
SCell Secondary Cell
TAG Timing Advance Group
TDD Time Division Duplex
TRP Transmission Reception Point
TTI Transmission Time Interval
UE User Equipment
UMTS Universal Mobile Telecommunications System

1. A method for use in a radio node of adapting a timing adjustment delay parameter, the method comprising:
obtaining information about timing adjustment for a cell;
determining a timing adjustment delay parameter for transmissions on the cell based on the obtained information about timing adjustment for the cell and at least one of a numerology and coverage level; and
applying a timing adjustment based on the determined timing adjustment delay parameter.

2-18. (canceled)

19. A radio node capable of adapting a timing adjustment delay parameter, the radio node comprising a memory coupled to a processor, the processor operable to:
obtain information about timing adjustment for a cell;
determine a timing adjustment delay parameter for transmissions on the cell based on the obtained information about timing adjustment for the cell and at least one of a numerology and coverage level; and
apply a timing adjustment based on the determined timing adjustment delay parameter.

20. The radio node of claim 19, wherein the processor is operable to apply the timing adjustment by updating a timing parameter, a timer, or a counter associated with one or more transmissions of the radio node.

21. The radio node of claim 19, wherein the processor is operable to determine the timing adjustment delay parameter for transmissions on the cell based on the numerology by decreasing a timing adjustment delay as a subcarrier spacing of the numerology increases.

22. The radio node of claim 19, wherein the radio node is in communication with a plurality of cells, and the numerology used for determining the timing adjustment delay parameter comprises a reference numerology associated with one cell of the plurality of cells.

23. The radio node of claim 19, wherein the obtained information about timing adjustment for the cell includes at least one of:
an amount of timing adjustment;
a timing adjustment delay;
one or more parameters characterizing a reference with respect to which the timing adjustment is to apply;
one or more parameters characterizing the timing adjustment including at least one of step size, frequency of the timing update, and maximum allowed adjustment;
an indication of one or more links or a group of links for which the timing adjustment can be applied: and
at least one of a carrier frequency, cell size, and cell range.

24. The radio node of claim 23 wherein the one or more parameters characterizing the reference with respect to which the timing adjustment is to apply include at least one of a cell, a downlink or uplink link, a downlink or uplink time unit, a downlink or uplink transmission, a downlink or uplink signal a reference numerology, a reference time or frequency resource, and a reference subband.

25. The radio node of claim 23, wherein the indication of the one or more links or the group of links for which the timing adjustment can be applied include at least one of one or more cells, a timing advance group (TAG), and a transmission reception point (TRP) associated with a link.

26. The radio node of claim 19, wherein the processor is operable to obtain information about tuning adjustment for the cell by at least one of:
receiving a message from another node;
obtaining a predefined value, table, mapping, function, or rule;
measuring a radio signal;
obtaining a coverage characterization;
obtaining a carrier aggregation (CA) configuration and TAG of the radio node; and
obtaining a numerology used for a particular link or group of links.

27. The radio node of claim 19, wherein the processor is operable to determine the timing adjustment delay parameter by at least one of:
determining a delay measured in an absolute time unit, measured in a radio time unit, or specified by a particular time resource;
determining a delay based on a predefined value, table, mapping, function, or rule:
determining a delay based on a radio measurement; and
determining a delay based on history.

28. The radio node of claim 27, wherein the predefined rule comprises at least one of:
a shorter liming adjustment delay for a larger subcarrier spacing in uplink;
a shorter timing adjustment delay for a larger subcarrier spacing in downlink;
a shorter timing adjustment delay for a larger subcarrier spacing which is the largest or the smallest among downlink and uplink;
a shorter delay for a smaller cell;
a shorter delay when a radio measurement is below a threshold;
a shorter delay for a cell bandwidth above a threshold;
a shorter delay for a channel condition above a threshold; and
a first delay for normal conditions and a second delay for extreme conditions.

29. The radio node of claim 19, wherein the radio node comprises a user equipment.

30. The user equipment of claim 29, wherein the processor is operable to apply the timing adjustment by applying the timing adjustment within a timing adjustment delay period determined based on the timing adjustment delay parameter.

31. The radio node of claim 30, wherein the processor is operable to apply the timing adjustment by applying the timing adjustment within a particular time resource determined based on the tinting adjustment delay parameter.

32. The user equipment of any claim 29, the processor further operable to transmit a radio transmission according to the applied timing adjustment.

33. The user equipment of claim 29, the processor further operable to indicate the timing adjustment capabilities of the user equipment to a controlling node.

34. The radio node of claim 19, wherein the radio node comprises an eNodeB.

35. The eNodeB of claim 34, wherein the processor is operable to apply the timing adjustment by sending the determined timing adjustment delay parameter to a user equipment.

36. (canceled)

37. A computer program product comprising instructions stored on non-transient computer-readable media which, when executed by a processor, perform the steps of:
obtaining information about timing adjustment for a cell;
determining u timing adjustment delay parameter for transmissions on the cell based on the obtained information about timing adjustment for the cell and at least one of a numerology and coverage level; and
applying a timing adjustment based on the determined timing adjustment delay parameter.

38. (canceled)

39. A radio node capable of adapting a timing adjustment delay parameter, the radio node configured to:
obtain information about timing adjustment for a cell, the obtained information comprising at least one of a numerology and coverage level;
determine a timing adjustment delay parameter for transmissions on the cell based on the obtained information about timing adjustment for the cell; and
apply a timing adjustment based on the determined timing adjustment delay parameter.

40. (canceled)
